(19) United States
(12) Patent Application Publication
(10) Pub. No.: US 2018/0363075 A1
(43) Pub. Date: Dec. 20, 2018

(54) METHOD FOR PRODUCING LIQUID PIG IRON

(71) Applicant: Primetals Technologies Austria GmbH, Linz (AT)

(72) Inventors: Franz HOLZLEITHNER, Laarkirchen (AT); Robert MILLNER, Loosdorf (AT); Wolfgang PANHUBER, Linz (AT); Norbert REIN, Wien (AT); Gerald ROSENFELLNER, Ertl (AT); Johann WURM, Bad Zell (AT)

(21) Appl. No.: 15/781,774

(22) PCT Filed: Apr. 26, 2017
(86) PCT No.: PCT/EP2017/059908

§ 371 Date: Jun. 6, 2018

(30) Foreign Application Priority Data
Apr. 27, 2016 (EP) 16167288.6

(51) Int. Cl. C21B 13/00; F27B 15/10

(52) U.S. Cl. CPC C21B 13/0073; F27B 15/10; C21B 13/0013

(57) ABSTRACT

A method for producing liquid pig iron (1), includes reducing iron-oxide-containing feed materials (2) to form a partially reduced first iron product (3) in a first reduction system (4), introducing the partially reduced first iron product (3), a first oxygen-containing gas (9, 9a), and a first carbon carrier (10) into a melter gasifier (11), introducing a second gaseous and/or liquid carbon carrier (13) and a second oxygen-containing gas (9b) into a mixing region (18) within the melter gasifier (11) above the fixed bed of the melter gasifier, mixing the second gaseous and/or liquid carbon carrier (13) with the second oxygen-containing gas (9b) in the mixing region (18), wherein the combustion air ratio is set in the range of 0.2 to 0.4, preferably between 0.3 and 0.35, in order to achieve partial oxidation of the second gaseous or liquid carbon carrier (13) within the mixing region (18), and mixing the gas resulting from the partial oxidation from the mixing region (18) with the gas in the remaining volume within the melter gasifier (11).

### CROSS-REFERENCE TO RELATED APPLICATIONS

The present application is a 35 U.S.C. §§ 371 national phase conversion of PCT/EP2017/059908, filed Apr. 26, 2017, which claims priority of European Patent Application No. 16167288.6, filed Apr. 27, 2016, the contents of which are incorporated by reference herein. The PCT International Application was published in the German language.

### FIELD OF THE INVENTION

The invention relates to a method for producing liquid pig iron, the method comprising
reducing iron-oxide-containing feed materials to form a partially reduced first iron product in a first reduction system by means of a reducing gas and drawing off the reducing gas consumed in the reduction as top gas or offgas,
introducing the partially reduced first iron product, a first oxygen-containing gas and a first carbon carrier into a melter gasifier,
gasifying the carbon carriers with the oxygen-containing gas and melting the partially reduced first iron product to form the liquid pig iron while producing the reducing gas in the melter gasifier,
introducing at least a partial amount of the reducing gas into the first reduction system by means of a reducing gas line.

In the case of such a smelting reduction process, gas cleaning systems (on the one hand for the top gas or off gas from the reduction system, on the other hand for the reducing gas from the melter gasifier) are also generally provided, and, depending on the system configuration, a device for removing CO₂ from the top gas or offgas, according to the prior art usually by means of pressure swing adsorption, if this gas is to be fed to a second reduction system or is to be used within the smelting reduction process.

Known smelting reduction processes are the Corex® process and the Finex® process. The Corex® process is a two-stage smelting reduction process. The smelting reduction combines the process of indirect reduction (pre-reduction of iron oxide to form iron sponge, often also referred to as direct reduction) with a smelting process (including residual reduction) in the so-called melter gasifier. The likewise known Finex® process differs from the Corex® process by the direct use of iron ore as fine ore, which is pre-reduced in a number of fluidized bed reactors arranged one behind the other.

### PRIOR ART

For the production of liquid pig iron, which is also intended to include the production of products similar to pig iron, there are essentially two known commonly used methods: the blast furnace method and smelting reduction, the latter for example as the Corex® process or Finex® process. The present invention relates to smelting reduction.

Smelting reduction uses a melter gasifier, in which hot liquid metal, preferably pig iron, is produced, and also at least one reduction system, for instance, at least one reduction reactor, in which the carrier of the iron ore (lump ore, fine ore, pellets, sinter) is at least partially reduced with reducing gas. The reducing gas is produced in the melter gasifier by gasifying mainly coal and coke with oxygen of technical purity (oxygen content of 90% or more). During this gasification, the required process heat is generated, and the reducing gas that is required for the upstream stages of the process, such as preheating, drying, iron reduction, calcination, etc.

Partially reduced means that the reduction degree of the iron carrier material is increased in the reduction reactor, but the reduction degree remains below 100%. The typical reduction degree, after the reduction system, is between 50% and 90%. The reduction degree RD is a measure of the depletion of the oxygen from the oxide of the iron carrier material and is described by the following formula

RD=(1−(O/(1.5*Feₜₒₜ))*100

where O denotes the amount-of-substance fraction of the iron carrier material accounted for by oxygen and Feₜₒₜ denotes the amount-of-substance fraction of the iron carrier material accounted for by iron (in each case in mol %).

In the case of the smelting reduction process, either so much solid carbon carrier is added that the amount of reducing gas produced is sufficient to achieve the desired partial reduction during the pre-reduction, with the disadvantage that the amount of carbon carriers consumed is uneconomically high, or less solid carbon carrier is added and the required amount of reducing gas is made available by returning and treating unconsumed process gas. This latter variant however additionally requires at least one compressor and a CO₂ removal system, which causes increased investment costs and increased energy consumption during operation.

### SUMMARY OF THE INVENTION

An object of the invention is therefore to provide a method for producing liquid pig iron with which method the consumption of solid carbon carriers in the melter gasifier can be reduced with lowest possible expenditure on additional equipment or capital expenditure.

The object is achieved by a method herein, in that the following further steps are carried out in the case of a method described at the beginning:
introducing a second gaseous and/or liquid carbon carrier and also a second oxygen-containing gas into a mixing region within the melter gasifier above the fixed bed (char bed) thereof,
mixing the second gaseous and/or liquid carbon carrier with the second oxygen-containing gas in the mixing region, the combustion air ratio being set in the range of 0.2 to 0.45, preferably between 0.3 and 0.35, to achieve partial oxidation of the second gaseous or liquid carbon carrier within the mixing region, and
mixing the gas resulting from the partial oxidation from the mixing region with the gas in the remaining volume within the melter gasifier.

According to the invention, therefore, significant amounts of only liquid, only gaseous or liquid and gaseous carbon carriers are used to produce reducing gas from them in the form of H₂ and CO, which reducing gas forms a significant part of the overall reducing gas produced in the melter gasifier. The term “second carbon carrier” means that it is different from the first carbon carrier. The second carbon carrier may, however, itself again comprise various substances and also be introduced at a number of points of the melter gasifier, to which extent it may of course also comprise third, fourth, etc. liquid and/or solid carbon carriers. The second gaseous or liquid carbon carrier may in particular contain natural gas, coke oven gas, alkanes and aromatics (for example coke tar).

The second oxygen-containing gas is preferably oxygen of technical purity with an O₂ content of at least 90%. This allows the nitrogen input into the melter gasifier to be kept low. It also applies here that the “second oxygen-containing gas” may contain gas from a number of sources and be introduced into the corresponding mixing region or mixing regions of the melter gasifier at a number of points, all of these gases being referred to as “second oxygen-containing gas”.

Therefore, according to the invention, a second gaseous or liquid carbon carrier, spatially independent of the first carbon carrier, and a second oxygen-containing gas, likewise spatially independent of the first oxygen-containing gas, are introduced into a mixing region (or a number of mixing regions) within the melter gasifier. As far as possible, this mixing region is not influenced by the remaining volume within the melter gasifier with regard to gas flows, reactions and temperature, in order that it is ensured that the second carbon carrier and the second oxygen-containing gas are mixed with one another without significant parts of the reducing gas that is within the melter gasifier already adding to this mixture before the second carbon carrier and the second oxygen-containing gas have reacted with one another.

The mixing of the second carbon carrier and the second oxygen-containing gas with the combustion air ratio according to the invention causes a partial oxidation, that is that the hydrocarbons of the second carbon carrier are predominantly converted into carbon monoxide CO and hydrogen H₂, and are consequently available as reducing constituents of the reducing gas.

In a small part (less than 25%), the oxygen of the oxygen-containing gas and the hydrocarbons are completely oxidized in the mixing region to form carbon dioxide CO₂ and water H₂O. It is consequently ensured that the temperatures in the mixing region are sufficiently high (above 1000° C.) to achieve a high rate of conversion into reducing gas.

Likewise in a small part (less than 10%), the hydrocarbons of the second carbon carrier are not broken down, or only into smaller hydrocarbons. These hydrocarbons that are not broken down, or only partially, can then be broken down further in the remaining volume within the melter gasifier by dust particles that are present in any case and act as a catalyst, also containing inter alia metallic iron, without it being necessary for catalysts to be added. For this reason, the resulting gas from the mixing region is also fed to the remaining volume within the melter gasifier.

Movable devices do not necessarily have to be provided for the mixing in the mixing region; sufficient mixing is usually achieved just by appropriate pressure and/or appropriate directions when the second carbon carrier and the second oxygen-containing gas are introduced. That is to say that the direction of the second carbon carrier when it is introduced into the mixing region may be different from the direction of the second oxygen-containing gas when it is introduced into the mixing region.

It is similarly probably unnecessary for a movable device to be provided specifically for mixing the resulting gas from the mixing region with the gas in the remaining volume of the melter gasifier. This is instead similarly being brought about just by the pressure and direction when the second carbon carrier and the second oxygen-containing gas are introduced, because, after all, there is in any case a spatial connection between the mixing region and the remaining volume of the melter gasifier. The resulting gas from the mixing region mixes with the gas in the remaining melter gasifier due to the heat produced as a result of the partial oxidation and due to the swirling of the second carbon carrier with the second oxygen-containing gas.

The combustion air ratio is usually denoted by lambda and is also known as the air ratio or air number. It is a dimensionless quantity from combustion theory that indicates the stoichiometric ratio of air, here the second oxygen-containing gas, and fuel, here the second carbon carrier, in a combustion process. With the combustion air ratio according to the invention, a degree of oxidation of less than 25%, in particular less than 15%, can be achieved in the partial oxidation and an average temperature of 1150-1500° C. can be achieved in the mixing region of the second oxygen-containing gas and the second carbon carrier.

It is admittedly known in principle also to introduce into a melter gasifier gaseous carbon carriers in addition to the first carbon carriers in lump form. See in this respect for instance WO 2015/000604 A1, where in one design variant sulfur-containing gas is introduced together with an oxygen-containing gas into the melter gasifier. However, the introduction takes place by means of a conventional oxygen burner which is not in fact designed to operate in such a way as to maximize the yield of reducing gas (H₂ and CO), while at the same time minimizing the formation of CO₂, H₂O and C, by setting a predefined mixing ratio. Moreover, the conventional oxygen burner according to WO 2015/000604 A1 lacks a defined spatial mixing region within the melter gasifier for mixing gas and oxygen. At least, partial oxidation under controlled conditions in the oxygen burner is not disclosed in WO 2015/000604 A1. Use of greater amounts of gaseous carbon carriers, as is possible in the case of the method according to the invention as a result of the mixing region, cannot be achieved by conventional oxygen burners without specific control of the oxygen-containing gas in relation to the gaseous carbon carriers, because without control, the degree of oxidation of the reducing gas formed would be too high for the pre-reduction of the iron carriers in the first reduction system.

In order to ensure a sufficiently high temperature for the partial oxidation with at the same time a high yield of the reducing gas components CO and H₂ in the mixing region without further devices, in a design variant it is provided that the mixing region is surrounded by the reducing gas that is in the melter gasifier. As a result, the heat losses of the mixing region are minimized. The gas surrounding the mixing region within the melter gasifier is typically at a temperature of 1050° C. while the reaction zone in the mixing region is at a temperature of 1150-1500° C., so that the reaction region of the mixing region is in any case not significantly cooled down by the surrounding gas. The dust in the gas within the melter gasifier that surrounds the mixing region additionally reduces the heat loss due to radiation of the mixing region to the surrounding reducing gas.

In order to achieve mixing of the second carbon carrier and the second oxygen-containing gas that is as undisturbed as possible, it may be provided that the mixing region is at least partially spatially separate from the remaining volume within the melter gasifier.

For this purpose, it may be provided that the mixing region is at least partially formed by an outwardly directed protrusion of the inner wall of the melter gasifier. The inner wall of the melter gasifier is therefore outwardly curved in a limited region, in relation to the surrounding region. The protrusion may for instance have approximately the form of a cylinder or the form of a spherical cap, in particular a hemisphere. In particular, the protrusion may be formed as a tube.

Where the protrusion adjoins the surrounding region of the inner wall of the melter gasifier (that is at the imaginary continuation of the inner wall of the melter gasifier if no protrusion were present), the cross-sectional area of the protrusion (always seen parallel to the surface area of the inner wall without a protrusion) is at its greatest, as would be the case with a protrusion in the form of a spherical cap. It may, however, also be the case that the protrusion has a greater cross-sectional area further outward, that is that the protrusion has a constriction where it adjoins the surrounding region of the inner wall. This constriction serves the purpose of delimiting the mixing region better from the remaining volume of the melter gasifier. In any case, the mixing region formed by a protrusion may be additionally increased in size by separating walls that protrude into the interior of the melter gasifier.

In order to achieve good conditions for a catalytic reaction of hydrocarbons that have not broken down when they leave the mixing region, it may be provided that the mixing region is above the fixed bed of the melter gasifier in a temperature range of 1000-1100° C., in particular around 1050° C. This will generally be the case if the mixing region is 1-2 m above the fixed bed of the melter gasifier, for example at the same height at which the dust burners are also arranged. This additionally ensures a sufficient dwell time after the mixing of the gas from the mixing region with the remaining reducing gas that does not originate from the mixing region.

In order to achieve the highest possible yield of reducing gas with the lowest possible input of solid carbon carriers, it may be provided that, in the case of a gaseous second carbon carrier, for example in the form of natural gas, more than 100 m³ of the second carbon carrier are fed to the melter gasifier per tonne of pig iron, in particular more than 140 m³ per tonne of pig iron.

The partial oxidation according to the invention of liquid or gaseous carbon carriers with oxygen of technical purity in the melter gasifier for the first reduction system allows a particularly low-nitrogen reducing gas to be produced, since it is possible to dispense with the gas recycling of top gas or offgas to the reducing gas and also with the introduction of pulverized coal, which usually takes place by means of nitrogen as the means of delivery. For this reason, the reducing gas produced according to the invention is also well suited for use in a downstream direct reduction system. In this case, it is possible for instance to dispense with a reformer for producing the reducing gas for the direct reduction system, since the reducing gas is produced in the melter gasifier by the method according to the invention. Correspondingly, it may therefore be provided that the top gas or offgas is at least partially introduced into a second reduction system, which is formed as a direct reduction shaft or as a fluidized bed and in which further iron-oxide-containing feed materials are reduced to form a partially reduced second iron product, in particular to produce iron sponge.

In a direct reduction system, lumpy iron ore carriers (lumpy ore or pellets) or fine ore in a solid state is/are reduced at 750-1000° C. by reducing gas. This produces direct reduced iron (DRI for short), which is also referred to as iron sponge. The direct reduction system contains as a key component a reduction reactor, which is formed either as a reduction shaft in the sense of a fixed bed reactor or in the form of fluidized bed reactors, into which the lumpy iron ore or fine ore and the reducing gas are introduced.

A direct reduction system may however also produce iron briquettes, the hot reduced oxide materials being agglomerated into larger units by means of hot briquetting (hot briquetted iron, HBI for short, or hot compacted iron, HCI for short). So-called low reduced iron (LRI for short) may also be drawn from the reduction shaft or fluidized bed reactor of a direct reduction system if the process is conducted appropriately.

A possible melter gasifier for carrying out the method according to the invention comprises at least
one iron product feed line for introducing the partially reduced first iron product,
one media feed line for introducing a first oxygen-containing gas and
one feed line for introducing a first carbon carrier into the melter gasifier.

The melter gasifier is characterized in that at least one carbon carrier line for introducing a second gaseous and/or liquid carbon carrier and also at least one media feed line for introducing a second oxygen-containing gas into a mixing region within the melter gasifier above the fixed bed thereof are provided, the mixing region being at least partially formed by an outwardly directed protrusion of the inner wall of the melter gasifier.

For example, it may be provided that the melter gasifier has a dome and a conical region adjoining thereto, and the protrusion is within 50-100%, in particular within 50-75%, of the height of the conical region. Or it may be provided that the melter gasifier has a dome and a conical region adjoining thereto, the lower part of the dome being formed as a cylindrical region, and the protrusion being within the cylindrical region.

The method according to the invention is distinguished by the fact that liquid or gaseous hydrocarbons can be used to a greater extent for producing liquid primary steel products, and less solid carbon carriers have to be used. The latter are not as readily available in some regions as liquid or gaseous hydrocarbons. Since liquid or gaseous hydrocarbons have a higher proportion of hydrogen than solid carbon carriers, this hydrogen can easily be used for the reduction. Compressors and CO₂ removal systems and the associated energy costs can be saved by the method according to the invention.

### BRIEF DESCRIPTION OF THE FIGURES

The invention is explained in more detail below on the basis of the figures, which are schematic and given by way of example.

FIG. 1 shows an integrated plant according to the invention comprising a melter gasifier and first and second reduction systems,

FIG. 2 shows the melter gasifier from FIG. 1, with a first embodiment of the mixing region,

FIG. 3 shows the melter gasifier from FIG. 1, with a second embodiment of the mixing region provided by a protrusion in the form of a tube.

### DESCRIPTION OF EMBODIMENTS

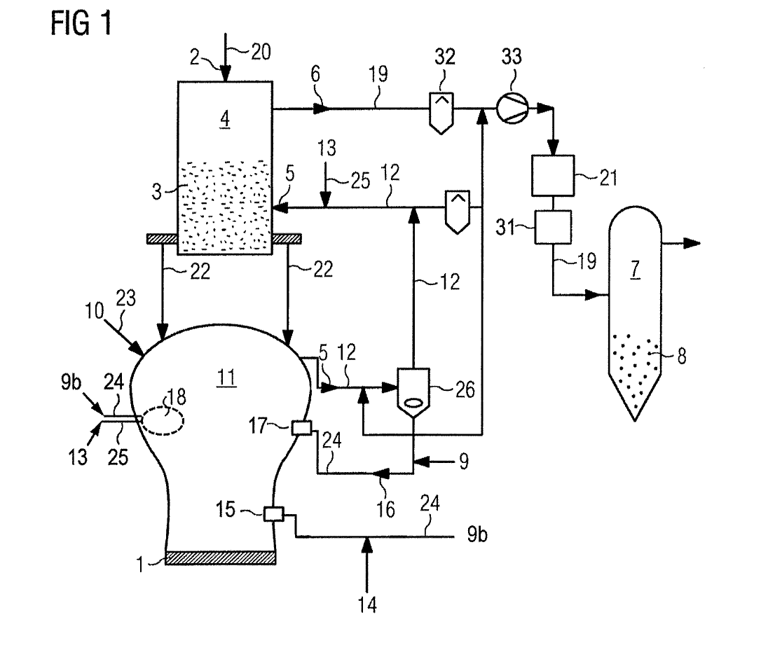

FIG. 1 shows a system for carrying out the method according to the invention for producing liquid pig iron 1 designed as a Corex® integrated direct reduction system. The iron-oxide-containing feed materials 2 are fed to a first reduction system 4, a Corex® reduction shaft with a fixed bed, by way of a feed line 20 for supplying iron-oxide-containing feed materials 2.

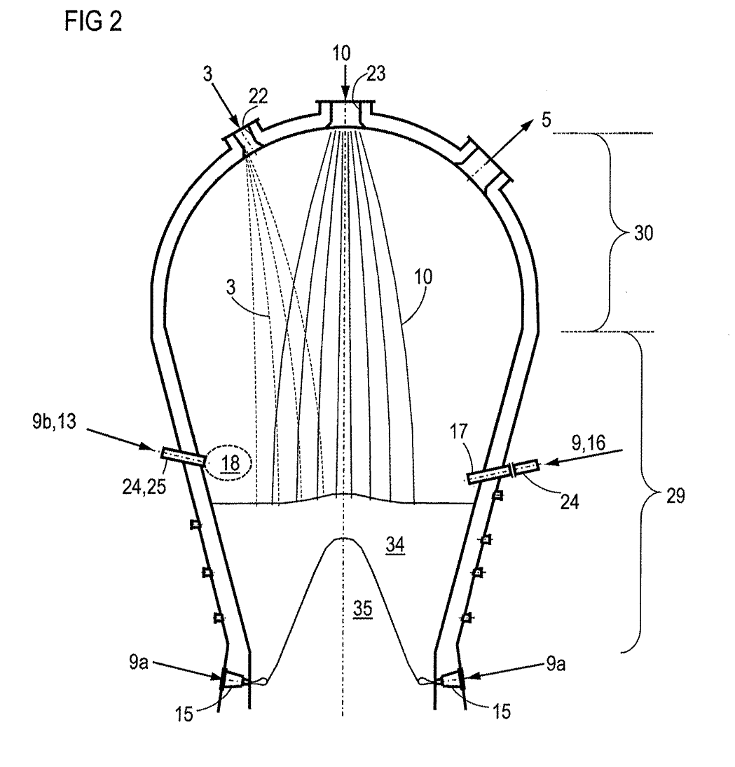

The iron-oxide-containing feed materials 2 are reduced by means of a reducing gas 5 to form a partially reduced first iron product 3 (FIG. 2), which is subsequently introduced by way of one or more iron product feed lines 22 opening out into a melter gasifier 11 and into the melter gasifier 11. Within the context of the present text, the iron product 3 comprises iron both in an oxidized, for example oxidic, form and in a reduced, that is metallic, form. In the iron product 3, the iron may take both forms. This is then referred to for example as pre-reduced iron carrier material, which though not yet finally reduced completely in comparison with a metallic form, is however already reduced more in comparison with a previous state. It may also take only one of the two forms. In the case of Corex®, the iron product 3 is for example hot, so-called direct reduced iron (DRI) or corresponding iron carrier material with a metalization, which means it is not yet considered to be DRI. In the case of the Corex® process, the iron product 3 is discharged from the reduction shaft of the first reduction system 4 charged with hot reducing gas 5 and is transported by means of gravitational force into the melter gasifier 11 by way of one or more chutes, and if appropriate distributor flaps. For example, a number of chutes may be provided, distributed over the circumference of the dome of the melter gasifier 11.

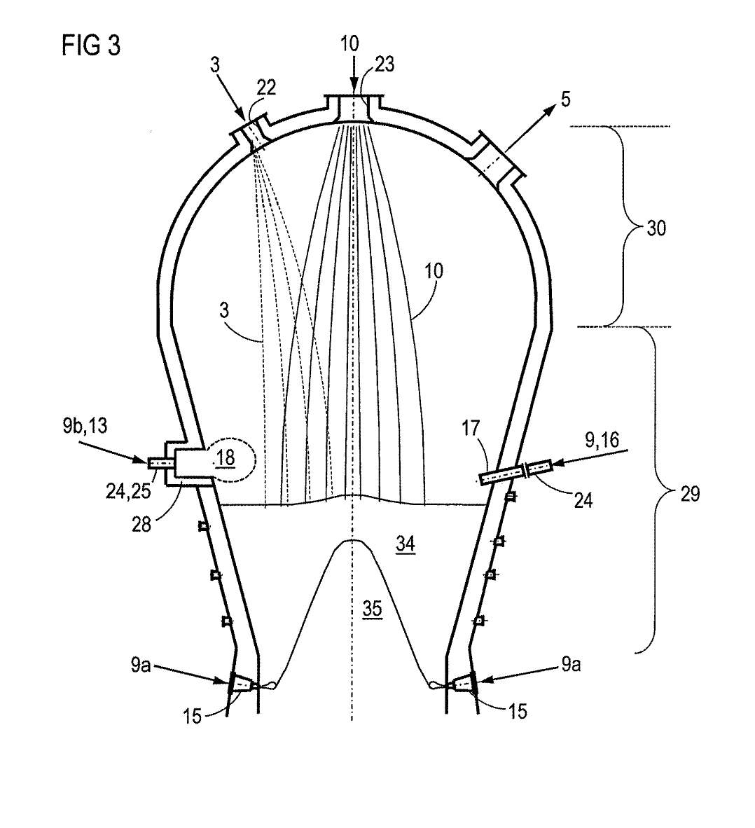

In addition, solid carbon carriers as the first carbon carrier 10, in the form of lump coal and/or agglomerated fine coal and/or coal-containing briquettes, are introduced into the melter gasifier 11 by way of a feed line 23, and first oxygen-containing gas 9, 9a is introduced by way of media feed lines 24. The charging of the first carbon carrier 10 and partially reduced iron product 3 into the melter gasifier 11 generally takes place separately from one another. The first carbon carrier 10 is for example supplied from a storage container for carbon-containing material by way of screw conveyors to a distributing device, which is mounted centrally in the dome of the melter gasifier 11 and by which the first carbon carrier 10 is distributed over the cross section of the melter gasifier 11 during the input into the melter gasifier 11, see in this respect FIGS. 2 and 3.

The carbon carriers 10, and if appropriate the fine coal 14, introduced into the melter gasifier 11 are gasified by means of the oxygen-containing gas 9a (FIG. 2) producing the reducing gas 5. This produces a gas mixture, which consists mainly of CO and H₂.

The reducing gas 5 is introduced into the first reduction system 4 by way of the reducing gas line 12, preceded by dedusting in a dedusting device 26. The separated dust is returned to the melter gasifier 11, to be specific, by means of one or more dust burners 17.

The first iron product 3 introduced into the melter gasifier 11 is melted by the heat produced during the gasification of the carbon carriers 10 to form the liquid pig iron 1. The hot metal smelted in the melter gasifier 11 and the slag are drawn off.

The reducing gas consumed during the reduction of the iron-oxide-containing feed materials 2 is referred to as top gas 6 and is drawn off as export gas from the first reduction system 4 by way of an export gas line 19 and cleaned there by means of wet scrubbers 32. The export gas may be compressed in a compressor 33, subsequently subjected to CO₂ removal 21 and heating 31 and be introduced into a second reduction system 7 for producing a partially reduced second iron product 8, in particular direct reduced iron (DRI) in the form of iron sponge. For this second reduction system 7 there is consequently no need for a system specifically for producing reducing gas, for example a reformer, since this process takes place in the melter gasifier 11.

After leaving the melter gasifier 11, part of the reducing gas 5 may be further cleaned in a wet scrubber 27, cooled and mixed in with the export gas 6.

The melter gasifier 11 receives introduction elements of three types opening out into the melter gasifier 11, which are formed as an oxygen nozzle 15, as a dust burner 17 and as a mixing region 18, and which however may in each case also be multiply present. On the outside, with respect to the melter gasifier 11, the introduction elements are connected to the media feed lines 24 for the second oxygen-containing gas 9b. There is at least one carbon carrier line 25, by means of which the second carbon carrier 13, which may be liquid and/or gaseous, is introduced into the melter gasifier 11. If the second carbon carrier is gaseous, there may additionally also be in each case a carbon carrier line 25 opening out into the reducing gas line 12.

A second carbon carrier 13 in liquid and/or in gas form, for example coke oven gas or natural gas, is fed to the melter gasifier 11 by way of the carbon carrier line 25, which opens out into the mixing region 18.

Coke oven gas has a typical composition of

65 percent by volume hydrogen (H₂),
2.5 percent by volume nitrogen (N₂),
6 percent by volume carbon monoxide (CO),
22 percent by volume methane (CH₄),
3 percent by volume other hydrocarbons (CₙHₘ),
1.5 percent by volume carbon dioxide (CO₂).

The carbon carrier line 25 may in this case be connected to a coking plant.

Natural gas has a typical composition of

75-99 percent by volume methane,
1-15 percent by volume ethane,
1-10 percent by volume propane.

In addition, hydrogen sulfide, nitrogen and carbon dioxide may be contained.

The second carbon carrier 13 and second oxygen-containing gas 9b in the form of oxygen of technical purity are introduced into the mixing region 18, which is provided just above the fixed bed of the melter gasifier 11 in the interior thereof, here at the same height as the dust burner 17, under the dome. The mixing region 18 is not separated here from the remaining interior space of the melter gasifier 11 by internal components, such as separating walls. During the operation of the melter gasifier 11, the mixing region 18 is evident by the reaction zone (flame), which is produced when there is complete oxidation of a small part (less than 25%) of the second carbon carrier 13 to form carbon dioxide CO₂ and water H₂O. The media feed line 24 for the second oxygen-containing gas 9b and the carbon carrier line 25 open out into the mixing region 18. The two lines may form an acute angle with one another, so that the second oxygen-containing gas 9b and the second carbon carrier 13 move toward one another within the mixing region 18 and as a result are mixed. There may also be a number of nozzles provided for each of the two media 9b, 13, arranged such that there is a swirling of the two media 9b, 13 when they enter the mixing region 18 through the nozzles.

The mixing of the second carbon carrier 13 and the second oxygen-containing gas 9b in the mixing region 18 causes a partial oxidation, that is the hydrocarbons of the second carbon carrier 13 are predominantly converted into carbon monoxide CO and hydrogen H₂. In a small part (less than 25%), the oxygen of the oxygen-containing gas 9b and the hydrocarbons are completely oxidized in the mixing region 18 to form carbon dioxide CO₂ and water H₂O. This produces a flame with a flame temperature of more than 1000° C., to be specific approximately between 1150 and 1500° C., whereby there is a sufficiently high temperature for the conversion into reducing gas.

The small part (less than 10%) of hydrocarbons of the second carbon carrier 13 that are not broken down, or are broken down only to smaller hydrocarbons, in the mixing region 18 can then be broken down further in the remaining volume within the melter gasifier 11 by dust particles that are present in any case and act as a catalyst, also containing inter alia metallic iron.

A number of such mixing regions 18 may of course be provided, for example a number of mixing regions 18 at the same height and distributed over the circumference of the melter gasifier 11, a number of mixing regions 18 one above the other, or a number of mixing regions one above the other and distributed over the circumference.

In FIG. 2, the melter gasifier 11 from FIG. 1 is shown by itself. A first carbon carrier 10 in the form of coal (solid lines) is introduced into the melter gasifier 11 through the middle outlet in the dome 30, into which the feed line 23 opens out. The first carbon carrier 10 is in this case supplied by a distributing device (not shown), which is mounted centrally in the dome of the melter gasifier 11 and by which the first carbon carrier 10 is distributed over the cross section of the melter gasifier 11.

The iron product 3 from the reduction shaft of the first reduction system 4, to be specific, the product is direct reduced iron DRI, is transported by means of gravitational force into the melter gasifier 11 by way of one or more iron product feed lines 22 formed as chutes. There is a plurality of such chutes distributed over the circumference of the dome 30 of the melter gasifier 11.

Iron product 3 and carbon carriers 10 fall down through the dome 30 into the conical region 29 of the melter gasifier 11 and form there the fixed bed 34, which here fills the conical region 29 to approximately halfway. There is however also the possibility of extending the lower part of the dome 30 in the form of a cylinder and shortening the conical region 29. In this case, the conical region 29 could even be completely filled with the fixed bed 34. The passage of the carbon carrier line 25 and the media feed line 24 or of the piece of line that is shown, and consequently also the mixing region 18, would then he arranged in the extended lower cylindrical region of the dome 30. In the center of the fixed bed 34, below the surface thereof, there is a reaction-free zone, which is referred to as the dead man 35.

Both the second carbon carrier 13 and the second oxygen-containing gas 9b are passed here through the wall of the conical region 29 by means of a piece of line that represents a continuation or unification of the carbon carrier line 25 and the media feed line 24. The carbon carrier 13 and the second oxygen-containing gas 9b may be mixed already in this piece of line. They may however also be carried separately in this piece of line (for instance in concentric pipes) and only mix in an end region of the piece of line, which is formed for example as a nozzle, or only after the end of the piece of line in the interior of the melter gasifier 11. In any case, the (further) mixing of the carbon carrier 13 and the second oxygen-containing gas 9b and a partial oxidation take place in the mixing region 18, which adjoins the piece of line shown.

The passage of the carbon carrier line 25 and the media feed line 24 or the piece of line shown lies here approximately between 50-75% of the height of the conical region 29 (measured from the bottom) of the melter gasifier 11. Consequently, the mixing region 18 is also at approximately between 50-75% of the height of the conical region 29. Depending on the embodiment, the arrangement may also lie above 75% of the conical region 29 or in the lower part of the dome 30, for instance if the lower part of the dome 30 is formed as a cylindrical region.

Shown in FIG. 3 is a variant of the design for the mixing region 18 in the form of a protrusion, which is formed here by a cylindrical tube 28. Otherwise, the construction of the melter gasifier 11 and of the Corex® plant are the same as FIG. 1 and FIG. 2.

The cylindrical tube 28 has been inserted into a corresponding opening in the melter gasifier 11 and finishes flush with the inner wall of the melter gasifier 11, that is, it does not protrude into the volume within the melter gasifier 11. The media feed line 24 for the second oxygen-containing gas 9b and the carbon carrier line 25 for the second carbon carrier 13 both open out into the mixing region 18, which on the one hand is formed by the tube 28 itself, on the other hand also protrudes into the remaining volume of the melter gasifier 11. Undisturbed mixing of the second oxygen-containing gas 9b and the second carbon carrier 13 can take place within the tube 28. The energy for the partial oxidation within the tube 28 in this case likewise is provided by the partial oxidation of the second carbon carrier 13, the losses being kept down by an appropriate refractory lining of the tube 28.

In order to ensure that the mixing region 18 extends as far as possible into the interior of the melter gasifier 11, and consequently the heat losses in the mixing region 18 can be kept down, the longitudinal axis of the tube 28 may be aligned normal to the tangential plane of the inner wall of the melter gasifier 11. In FIG. 3, the tube 28 is aligned approximately horizontally.

The diameter of the tube 28 is generally a multiple of the diameter of a media feed line 24 or of a carbon carrier line 25 or of a dust burner 17 or of the outlet opening of an oxygen nozzle 15.

In order to be able to convert more of the second carbon carrier 13, a number of tubes 28 per melter gasifier 11 may be provided. In this case, the tubes 28 and the associated mixing regions 18 may be distributed over the circumference and/or the height of the melter gasifier 11, as explained in the case of FIG. 1.

The two lines 24, 25 may again form an acute angle with one another, so that the second oxygen-carrying gas 9b and the second carbon carrier 13 move toward one another within the mixing region 18, in particular within the tube 28, and as a result are mixed. There may also be a number of nozzles provided for each of the two media 9b, 13, arranged such that there is a swirling of the two media 9b, 13 when they enter the mixing region 18, in particular the tube 28, through the nozzles.

Both for mixing regions 18 without a protrusion and for mixing regions 18 with a protrusion, they are preferably arranged 1-2 m above the fixed bed 34. As shown in FIGS. 2 and 3, the mixing region or regions 18 may for example be under the dome 30 of the melter gasifier 11 in the conical region 29 of the melter gasifier 11 or in the lower part of the cylindrically extended dome 30. The conical region 29 is the frustoconically upwardly widening part of the melter gasifier 11, to which the approximately hemispherical dome 30 adjoins.

If instead of the Corex® plant a Finex® plant is used, after the last of the three to four fluidized bed reactors, in which the pre-reduction of the fine ore takes place, a partial stream of the offgas is removed as export gas, and otherwise used as in FIG. 1. As in the case of the Corex® plant, part of the surplus gas from the melter gasifier 11 may also be added to the export gas.

### LIST OF DESIGNATIONS

1 liquid pig iron
2 iron-oxide-containing feed materials
3 partially reduced first iron product
4 first reduction system
5 reducing gas
6 top gas
7 second reduction system
8 partially reduced second iron product
9 oxygen-containing gas
9a first oxygen-containing gas
9b second oxygen-containing gas
10 first carbon carrier
11 melter gasifier
12 reducing gas line
13 second carbon carrier
14 fine coal
15 oxygen nozzle
16 dust
17 dust burner
18 mixing region
19 export gas line
20 feed line for supplying iron-oxide-containing feed materials
21 CO₂ removal
22 iron product feed line
23 feed line for the first carbon carrier 10
24 media feed line
25 carbon carrier line
26 dedusting device
27 wet scrubber
28 protrusion (tube)
29 conical region of the melter gasifier 11
30 dome of the melter gasifier 11
31 heating
32 wet scrubber for top gas
33 compressor
34 fixed bed
35 dead man

1. A method for producing liquid pig iron, comprising:
reducing iron-oxide-containing feed materials to form a partially reduced first iron product in a first reduction system by means of a reducing gas;
drawing off the reducing gas consumed in the reduction as top gas or offgas;
introducing the partially reduced first iron product, a first oxygen-containing gas and a first carbon carrier into a melter gasifier;
gasifying the carbon carriers with the oxygen-containing gas and melting the partially reduced first iron product to form the liquid pig iron while producing the reducing gas in the melter gasifier;
introducing at least a partial amount of the reducing gas into the first reduction system by means of a reducing gas line,
introducing a second gaseous and/or liquid carbon carrier and also a second oxygen-containing gas into a mixing region within the melter gasifier above the fixed bed thereof;
mixing the second gaseous and/or liquid carbon carrier with the second oxygen-containing gas in the mixing region, the combustion air ratio being set in the range of 0.2 to 0.45, to achieve partial oxidation of the second gaseous or liquid carbon carrier within the mixing region; and
mixing the gas resulting from the partial oxidation from the mixing region with the gas in the remaining volume within the melter gasifier.

2. The method as claimed in claim 1, further comprising the second oxygen-containing gas is oxygen of technical purity with an O₂ content of at least 90%.

3. The method as claimed in claim 1, wherein the mixing of the second gaseous and/or liquid carbon carrier with the second oxygen-containing gas takes place only by the pressure and direction of the second gaseous and/or liquid carbon carrier and the second oxygen-containing gas when they are introduced.

4. The method as claimed in claim 1, further comprising the mixing of the gas resulting from the partial oxidation from the mixing region with the gas in the remaining volume within the melter gasifier takes place only by the pressure and direction when the second carbon carrier and the second oxygen-containing gas are introduced.

5. The method as claimed in claim 1, further comprising the mixing region is at least partially surrounded by the reducing gas that is in the melter gasifier.

6. The method as claimed in claim 1, further comprising the mixing region is at least partially spatially separate from the remaining volume within the melter gasifier.

7. The method as claimed in claim 1, further comprising the mixing region is at least partially formed by an outwardly directed protrusion of the inner wall of the melter gasifier.

8. The method as claimed in claim 1, further comprising the mixing region is above the fixed bed of the melter gasifier and is in a temperature range of 1000-1100° C.

9. The method as claimed in claim 1, further comprising at least one mixing region is 1-2 m above the fixed bed of the melter gasifier.

10. The method as claimed in claim 1, further comprising, for use when a gaseous second carbon carrier, more than 100 m³ of the second carbon carrier are fed to the melter gasifier per ton of pig iron.

11. The method as claimed in claim 1, wherein the top gas or offgas is at least partially introduced into a second reduction system, which is formed as a direct reduction shaft or as a fluidized bed and in which further iron-oxide-containing feed materials are reduced to form a partially reduced second iron product.

12. A melter gasifier for carrying out the method as claimed in claim 1, comprising:
a melter gasifier;
an iron product feed line for introducing the partially reduced first iron product;
a media feed line for introducing a first oxygen-containing gas and
a feed line for introducing a first carbon carrier into the melter gasifier;
at least one carbon carrier line for introducing a second gaseous and/or liquid carbon carrier;
at least one media feed line for introducing a second oxygen-containing gas into a mixing region within the melter gasifier and above a fixed bed of the melter gasifier, the mixing region being at least partially formed by an outwardly directed protrusion of the inner wall of the melter gasifier.

13. The melter gasifier as claimed in claim 12, further comprising: the melter gasifier has a dome and a conical region adjoining the dome; and
the protrusion is within 50-100%, of the height of the conical region.

14. The melter gasifier as claimed in claim 13, wherein a lower part of the dome is formed as a cylindrical region, and the protrusion is within the cylindrical region.

15. A method for producing liquid pig iron, comprising:
reducing iron-oxide-containing feed materials to form a partially reduced first iron product in a first reduction system by means of a reducing gas;
drawing off the reducing gas consumed in the reduction as top gas or offgas,
introducing the partially reduced first iron product, a first oxygen-containing gas and a first carbon carrier into a melter gasifier;
gasifying the carbon carriers with the oxygen-containing gas and melting the partially reduced first iron product to form the liquid pig iron while producing the reducing gas in the melter gasifier;
introducing at least a partial amount of the reducing gas into the first reduction system by means of a reducing gas line;
introducing a second gaseous and/or liquid carbon carrier and also a second oxygen-containing gas into a mixing region within the melter gasifier above the fixed bed thereof;
mixing the second gaseous and/or liquid carbon carrier with the second oxygen-containing gas in the mixing region, the combustion air ratio being set in the range of 0.3 to 0.35, to achieve partial oxidation of the second gaseous or liquid carbon carrier within the mixing region; and
mixing the gas resulting from the partial oxidation from the mixing region with the gas in the remaining volume within the melter gasifier.

16. The method as claimed in claim 1, further comprising the mixing region is above the fixed bed of the melter gasifier and is in a temperature range of around 1050° C.

17. The method as claimed in claim 1, wherein the top gas or offgas is at least partially introduced into a second reduction system, which is formed as a direct reduction shaft or as a fluidized bed and in which further iron-oxide-containing feed materials are reduced to form a partially reduced iron sponge.

18. The melter gasifier as claimed in claim 12, further comprising:
the melter gasifier has a dome and a conical region adjoining to the dome; and
the protrusion is within 50-75%, of the height of the conical region.
